(19) United States
(12) Patent Application Publication
(10) Pub. No.: US 2008/0196593 A1
(43) Pub. Date: Aug. 21, 2008

(54) Espresso maker and method

(76) Inventors: James P. Shrader, Jacksonville, FL (US); Soren G. Brockdorf, Jacksonville, FL (US)

Correspondence Address: ROGERS TOWERS, P.A., 1301 RIVERPLACE BOULEVARD, SUITE 1500, JACKSONVILLE, FL, 32207, US

(21) Appl. No.: 12/070,249

(22) Filed: Feb. 15, 2008

Related U.S. Application Data
(60) Provisional application No. 60/902,010, filed on Feb. 16, 2007.

(51) Int. Cl. A47J 31/057; A47J 31/00; A47J 31/44

(52) U.S. Cl. 99/300; 99/323; 99/279

(57) ABSTRACT

An espresso maker and method of producing espresso, the espresso maker having a chamber to receive hot water and a coffee filter pod, the water and filter pod in the chamber being pressurized by an outside source of compressed gas to approximately 15 bar. The hot water is allowed to contact the filter pod for a short time prior to pressurization, and the chamber is maintained at the desired minimum pressure for a short time after pressurization prior to opening of a release valve to allow flow of liquid through the filter pod and into a container.

This application claims the benefit of U.S. Provisional Patent Application No. 60/902,010, filed Feb. 16, 2007.

### BACKGROUND OF THE INVENTION

This invention relates generally to the field of devices and methods used to produce coffee drinks, and more particularly to devices and methods used to produce espresso. Even more particularly, the invention relates to such devices and methods that utilize compressed gas.

Coffee and espresso makers are well known, with the devices ranging in size from those producing a single cup at one time to those producing multiple cups. Espresso is a coffee drink that is made using hot water at higher-than-atmospheric pressure so as to extract more soluble compounds from the coffee beans than is extracted in the production of standard coffee, the water being forced through finely ground coffee beans. The added pressure extracts desirable compounds that are left behind in other brewing methods, producing a thick, strong coffee drink with naturally occurring emulsified oils, called crema. Espresso drinkers tend to be very particular about the taste of the product, and it is imperative that an espresso maker be able to achieve the necessary temperature and pressure during the process, because failure to do so produces an inferior product. Most espresso making machines are therefore relatively expensive pieces of equipment.

Attempts to produce an espresso maker that is small, relatively inexpensive and portable have been generally unsuccessful to date, as these requirements usually result in a device which cannot produce sufficient pressure, sufficient temperature, or both, and which attempts to produce espresso with a method which cannot produce a true espresso drink that satisfies connoisseurs of the beverage.

A recent approach has been to utilize compressed gas from a small gas cylinder or canister, whereby the gas is used to force a measured quantity of hot water through the ground coffee beans, often retained within a permeable pod, and into a small cup or other container. Once the water has been fully evacuated, the gas pressure is then shut off. Examples of this type of system can be found in U.S. Patent Application Publication No. 2007/0199452 to Dworzak et al., in WIPO Publication No. WO/12007/088309 to Handpresso, and in a commercial product currently being marketed under the brand HANDPRESSO. In all of these devices, the compressed gas acts in the manner of a piston—the gas merely forcing the water through the coffee pod or ground coffee beans. A cup-sized quantity of water is provided within a chamber in the device, the water being either pre-heated or subsequently heated by the device itself. The coffee filter pods or ground coffee beans are then placed into the device, and the compressed gas is released to move the water. In the Dworzak published application, the compressed gas is directed into the water chamber, which is separated from the ground coffee beans by a tubular conduit. As the pressure rises, the water is pushed through the conduit and through the ground coffee beans or filter pod. In the Handpresso devices, a gas chamber separate from the water chamber is first pressurized up to a desired minimum pressure by release of gas from a cylinder or by a hand pump. The water and coffee filter pod are then added to the device, and the gas is released from the gas chamber. In all these devices, as soon as the compressed gas is released, water flow commences through the ground coffee beans into the cup. Because the compressed gas is used merely to force the water through the ground coffee beans or filter pod, the pressure against the water begins to diminish immediately as liquid flows into the cup. All brewing or infusion, i.e., the transfer of compounds and emulsified oils to the hot water to create the espresso liquid occurs only while the water passes through the filter pod.

It has been discovered that a more flavorful cup of espresso may be produced utilizing a different device and method, wherein instead of using the compressed gas as the means to drive the water through the ground coffee beans with immediate release of liquid upon release of the compressed gas, the compressed gas is used to bring the combination of water and coffee up to a minimum desired pressure in a closed chamber. In other words, the chamber containing the hot water and the coffee pod or ground coffee is pressurized after the water has been in contact with the ground coffee beans for a short period of time such that infusion has already begun and then continues to occur under elevated pressure. After the minimum desired pressure has been attained in the water/coffee chamber, infusion is allowed to occur for another short period and then the liquid espresso is released into the cup.

It is an object of this invention to provide an espresso maker capable of producing true espresso in single cup batches, wherein compressed gas is used to bring a chamber containing hot water and ground coffee beans up to a minimum desired pressure for optimum infusion prior to release of the liquid espresso into a cup or other container. It is a further object to provide such an invention in various embodiments, such that the invention may be small, portable and handheld, or may be a stand-alone countertop embodiment suitable for use in a kitchen or for transport on a wheeled cart. It is further object to provide such an invention wherein preferably the compressed gas is provided by a cylinder or small canister, and wherein various gases may be utilized.

### SUMMARY OF THE INVENTION

The invention is a small, preferably portable, espresso maker device and the method of using this device to produce espresso in single cup or small batch serving sizes. In a handheld embodiment, the device comprises a cap member removably joined to a base member, both being composed of material that is able to withstand high pressure and temperature. The base member and cap member in combination define a closed water chamber to receive water and a coffee filter pod. Coffee filter pod securing means are provided such that a filter pod containing ground coffee beans is retained above the major portion of the water chamber, i.e., adjacent or relatively near one end of the water chamber. A pressurization inlet valve is provided such that the chamber pressure can be raised (preferably up to at least approximately 15 bars or 217 psi for espresso) by the introduction of pressurized gas from a pressurized gas dispenser, or by the use of a hand pump or the like. While the desired pressurization could be achieved using automatic metering systems, preferably a visual pressure gauge is provided such that the chamber pressure can be easily monitored from the outside of the device. A release outflow valve is provided in the cap member to release the espresso into a cup or other container for consumption.

The method of producing espresso comprises the steps of introducing hot water into the base chamber, or providing water in the chamber and then heating it using resistance heaters, microwaves or other heating means, securing a coffee filter pod between the base member and the cap member, allowing infusion to begin for a short time period, and then introducing pressurized gas into the chamber to raise the pressure of the water/coffee infusion. Because the hot water is in contact with the filter pod before, during and after pressurization is achieved, the coffee extracts are infusing into the water during the entire pressurization. When the internal pressure has reached the desired minimum pressure (most preferably approximately 15 bar for espresso), the gas flow is stopped, the infusion is allowed to occur for another short time period, and the release outflow valve is opened, whereby espresso or coffee slowly flows from the device into the cup.

In alternative embodiments the operative components may be positioned within a stand-alone housing, such that the unit may be used in a kitchen counter-top setting or moved about on a wheeled cart.

### BRIEF DESCRIPTION OF THE DRAWINGS

FIG. 1 is an exploded view of an embodiment of the invention, shown partially in cross-section.

FIG. 2 is a view of the embodiment of FIG. 1 showing the cap member joined to the base member and a pressurized gas dispenser connected to the pressurization valve.

FIG. 3 is an exploded view of an alternative embodiment of the base and cap member.

### DETAILED DESCRIPTION OF THE INVENTION

With reference to the drawings, the invention will now be described in detail with regard for the best mode and the preferred embodiment. In general, the invention is an espresso maker device and the method of producing espresso using the device. For ease of discussion, the invention will be described below primarily with regard for its use as an espresso maker, but with the understanding that it could be used to make regular coffee by operating the device at a lower pressure.

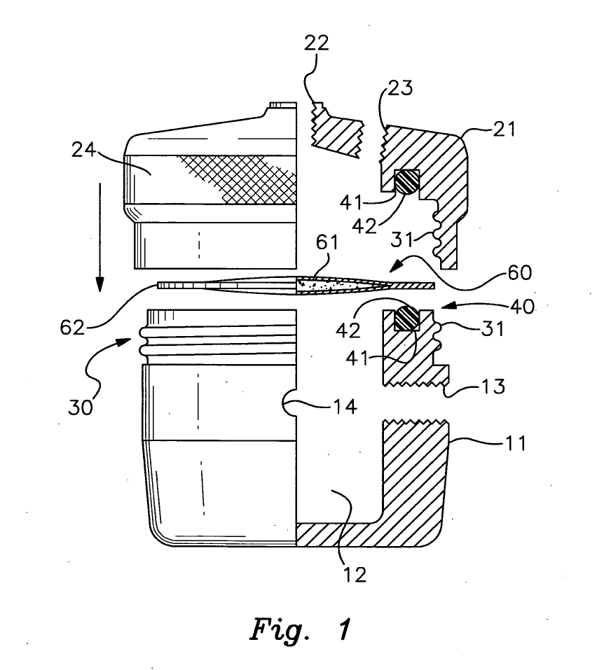

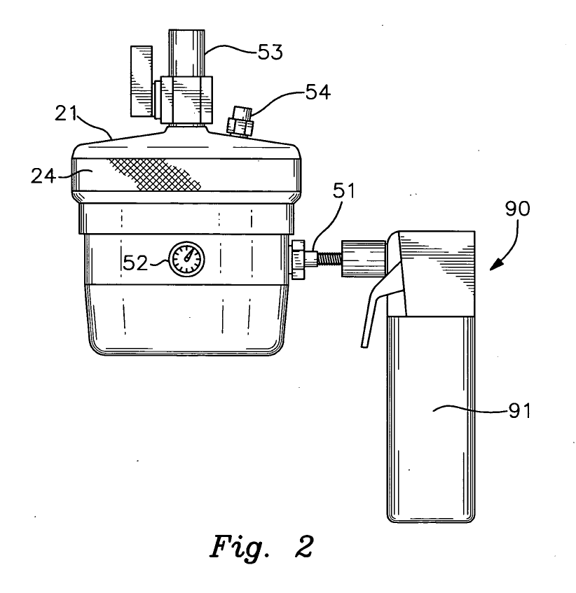

In the embodiment shown in FIGS. 1 and 2, the device comprises a base member 11 having a generally cup-like configuration defining an open-topped, sealable chamber 12. Chamber 12 is sized so as to be able to receive and retain approximately 1.75 ounces of water, which is a suitable amount to produce a typical espresso shot. A pressurization port 13 is provided in the wall of the base member 11, the pressurization port 13 receiving a pressurization valve 51 such that pressurized gas may be introduced into the chamber 12 using suitable pressurization means 90, such as a gas canister 91, a hand pump, etc. For the production of espresso, the pressurization means 90 should preferably be capable of pressurizing the chamber 12 up to or in excess of approximately 15 bar (about 217 psi) when it is retaining water. This pressure can be reached very rapidly using a small, trigger-operated gas canister 91 due to the small volume of the chamber 12. The device further comprises a cap member 21, the cap member 21 having a liquid release port 22 to receive a drain or liquid release outflow valve 53. Optionally, the device may further comprise a pressure relief port 23 (which could also be disposed in the base member 11, or omitted entirely) to receive a pressure relief safety valve 54. Preferably, the cap member 21 is provided with gripping means 24, such as a textured annular surface, a handle, etc., to provide a means to more easily tighten and release the cap member 21 from the base member 11. Connecting means 30 are provided for joining the cap member 21 to the base member 11 in a tight, secure, yet releasable manner, such as for example a combination of threading 31, mechanical latches, hinges, slots and tabs, etc. The base member 11 and the cap member 21 are composed of material able to withstand high pressure and high temperature, such as for example, aluminum, stainless steel, ceramics, specialty polymers, etc. Proportions, dimensions and configurations may vary somewhat without departing from the spirit of the invention.

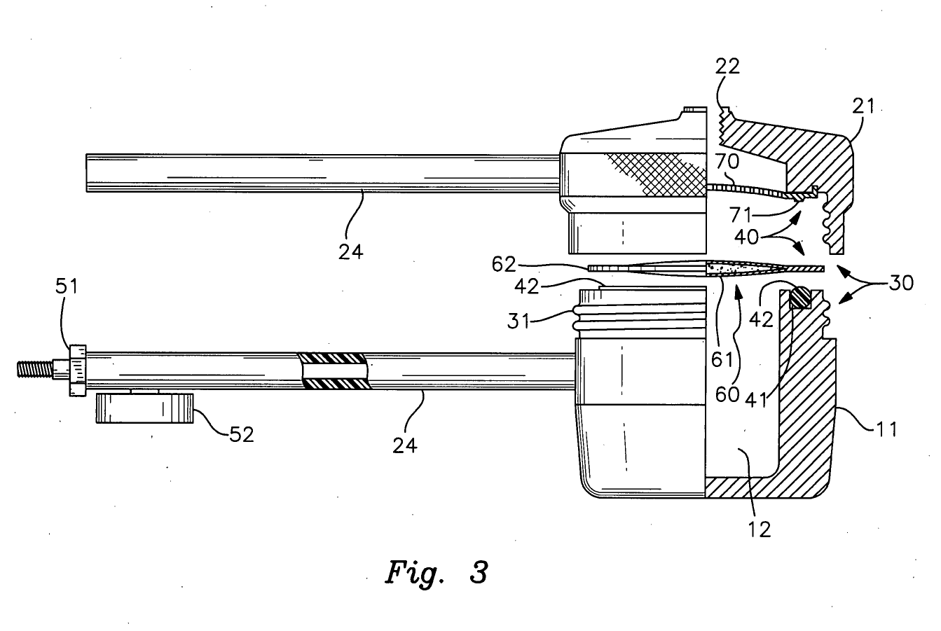

The device further comprises means 40 for retaining a ground coffee bean infusing member 60, such as a coffee filter pod 61, at or adjacent the top of the chamber 12 in the base member 11, coffee filter pods 61 being known in the art and typically comprising a disk-shaped body retaining a quantity of finely ground coffee and a peripheral skirt or flange member 62. Alternatively, a reusable, finely perforated infuser member (not shown) made of stainless steel or the like could be used in place of the pre-manufactured filter pods 61 to retain fresh ground coffee beans. The infusing member retaining means 40 must be able to retain the pod filter 61 in a manner such that water contained in the base member chamber 12 is forced through the pod filter 61 under pressure, which is typically accomplished by clamping the pod skirt 62 between two opposing annular surfaces. In the embodiment shown in FIGS. 1 and 2, the infusing member retaining means 40 comprises a pair of channels or grooves 41 containing O-rings or similar gaskets 42, such that the pod skirt 62 is secured between the two O-rings 42 when the cap member 21 is screwed onto the base member 11. Alternatively, as shown in the embodiment of FIG. 3, one set of groves 41 and O-rings 42 can be replaced with a raised annular bead surface 71 to press the skirt 62 against the other O-ring 42, or equivalent retention means could be utilized. With the pod filter 61 in place, all water must pass through the pod filter 61 to reach the release outflow valve 53. Because the water and coffee filter pod 61 are subjected to high pressure prior to and during the release the water through the pod 61, it is most preferred that a perforated pod support member 70 be provided between the coffee filter pod 61 and the outflow port 22, such that rupture of the pod 61 is precluded during pressurization or liquid release. Most preferably, the pod support member 70 is a thin stainless steel member with relatively fine perforations to allow for liquid passage, the pod support member 70 being press-fit or otherwise suitably attached to the cap member 21, as shown in FIG. 3.

Various types of valves and gauges may be utilized. For example, the pressurization valve 51 may comprise the type known as a Presta or Schrader valve. The pressure gauge 52 may provide an analog or digital readout, or may comprise a pop-up type valve. It is most preferable that the drain or release valve 53 be of a type that allows for a gradual release of pressure to insure that the espresso is released slowly rather than in a burst or as a strong stream. It is also contemplated that the device could be provided with external or internal thermal insulation means to improve its ability to retain temperature.

In the alternative embodiment of the device shown in FIG. 3, the gripping means 24 is shown to comprise a pair of extended handles that provide the means to rotate the cap member 21 relative to the base member 11 and to hold the device during the pressurization and infusion process. The handle connected to the base member 11 is a hollow conduit leading from the pressurization valve 51 to the chamber 12, the pressurization valve 51 being mounted on the free end of the handle for attachment of the pressurization means 90, to chamber 12.

To make espresso in the invention, the user first heats water to boiling—either separately from the base member 11 or in the base member 11 itself, such as with a stove, a microwave, an electric immersion coil or the like. It is also possible to provide a removable receptacle that fits within the chamber 12, such that the removable receptacle may be externally heated and then replaced in the chamber 12. It is also possible to provide an internal heating element, such as a coil, that can be utilized in circumstances where electrical power is available. With the high temperature water (preferably at or above 185 degrees F.) poured into the chamber 12 of the base member 1, the filter pod 61 is placed atop the base member 11 and the cap member 21 is joined to the base member 11, thereby securing the filter pod 61 in place. The device is then inverted such that the water contacts the filter pod 61. After a period of about eight to ten seconds to allow full hot water penetration of the filter pod 61 and the onset of infusion and brewing, the chamber 12 is pressurized (most preferably to at least approximately 15 bar), such as by delivering compressed gas from the compressed gas canister 91 through the pressurization valve 51. Preferably nitrogen, nitrous oxide, oxygen, argon gas, carbon dioxide or a blend of these gases, is utilized. It has been found that of these gases, nitrous oxide and argon produce high quality product. Alternatively, a hand pump or similar means could be used as the pressurization means 90 to deliver compressed air or other gas into the chamber 12. The gas flow is then stopped and the pressure within the chamber 12 is held constant, and then after a period of about eight to ten seconds to allow infusion to occur under high pressure, the release valve 53 is then opened to slowly release the espresso liquid into a container. Preferably, the espresso is released over a period of about thirty seconds into the container. Because the hot water is in contact with the filter pod 61 before, during and after the pressurization operation, infusion of the desirable compounds and oils from the finely ground coffee beans is optimized and continues until the liquid is released into the cup, thereby producing a strong, thick, high quality espresso drink with a naturally occurring crema.

An alternative embodiment of the invention is possible wherein a self-supporting housing is provided to receive the operative components, such that the device may be utilized for example on a counter-top or a movable cart as a stand-alone unit. In this case, the brewing chamber 12 would be provided with an upper cap member 21 or a conduit means for delivery of the hot water into the chamber 12 after a coffee filter pod 61 has been disposed beneath the chamber 12, such as by providing a hinged or fully removable lower cap containing a dispensing member to retain the filter pod 61. The release valve 53 would be disposed in the dispensing member.

One significant advantage to the invention over the prior art systems that do not provide a closed chamber 12 during pressurization, in addition to the production of a higher quality cup of espresso, is that the quantity of gas required to produce a cup of espresso is significantly reduced, since the only gas utilized is the small amount required to pressurize chamber 12. In many of the known prior art systems, the gas runs continuously until after all the water has been expelled, thereby wasting a significant amount of gas and raising the brewing cost per cup.

It is contemplated that equivalents or substitutions for elements set forth above may be obvious to those skilled in the art, and therefore the true definition and scope of the invention is to be asset forth in the following claims.

We claim:

1. An espresso maker device comprising:
a water-receiving chamber, said chamber sealed by a liquid release outflow valve in communication with said chamber;
means for retaining a ground coffee infusing member within said chamber, whereby water within said chamber must first pass through said ground coffee infusing member to pass through said liquid release outflow valve; and
pressurization means to raise the pressure within said chamber when said chamber contains water in contact with said ground coffee infusing member and said chamber is closed by said release outflow valve.

2. The device of claim 1, said chamber comprising a cap member removably joined to a base member.

3. The device of claim 1, wherein said pressurization means comprises a compressed gas delivered into said chamber.

4. The device of claim 3, wherein said pressurization means further comprises a gas canister.

5. The device of claim 1, further comprising a pressure gauge indicating the pressure within said chamber.

6. The device of claim 1, wherein said ground coffee infusing member comprises a coffee filter pod.

7. An espresso maker device comprising:
a water-receiving chamber comprising a cap member removably joined to a base member;
a liquid release outflow valve mounted on said cap member and in communication with said chamber;
means for retaining a ground coffee infusing member within said chamber, whereby water within said chamber must first pass through said ground coffee infusing member to pass through said liquid release outflow valve;
pressurization means to raise the pressure within said chamber when said chamber contains water in contact with said ground coffee infusing member and said chamber is closed by said release outflow valve, said pressurization means comprising compressed gas delivered into said chamber; and
a pressure gauge indicating the pressure within said chamber.

8. The device of claim 7, wherein said pressurization means further comprises a gas canister.

9. The device of claim 7, wherein said pressurization means further comprises a pressurization valve, such that said compressed gas is delivered into said chamber through said pressurization valve.

10. The device of claim 7, wherein said ground coffee infusing member comprises a coffee filter pod.

11. The device of claim 8, wherein said ground coffee infusing member comprises a coffee filter pod.

12. The device of claim 10, further comprising a perforated support member to support said coffee filter pod.

13. The device of claim 7, further comprising a handle attached to said base member.

14. The device of claim 13, wherein said handle comprises a conduit into said chamber, whereby said compressed gas is delivered through said handle into said chamber.

15. The device of claim 9, further comprising a handle attached to said base member, wherein said handle comprises a conduit into said chamber, whereby said pressurization valve is mounted onto said handle and said compressed gas is delivered through said handle into said chamber.

16. The device of claim 9, wherein said pressurization means is capable of raising the pressure within said chamber to approximately 15 bar.

17. A method of making espresso comprising the steps of:
providing a valved, closed chamber containing a ground coffee infusing member and hot water in contact with said ground coffee infusing member to begin producing espresso liquid;
raising the pressure of said chamber while said hot water is in contact with said ground coffee infusing member to continue producing espresso liquid;
holding the pressure constant in said chamber to continue producing espresso liquid; and
releasing said espresso liquid from said chamber through said ground coffee infusing member.

18. The method of claim 17, wherein said hot water is in contact with said ground coffee infusing member for approximately eight to ten seconds prior to raising the pressure.

19. The method of claim 18, wherein said pressure within said chamber is held constant for approximately eight to ten seconds.

20. The method of claim 19, wherein said pressure within said chamber is raised to approximately 15 bar.
